(19) United States
(12) Patent Application Publication
(10) Pub. No.: US 2025/0207903 A1
(43) Pub. Date: Jun. 26, 2025

(54) SCRATCH DEPTH COMPARATOR, ASSEMBLY, AND METHOD OF MAKING A SCRATCH DEPTH COMPARATOR

(71) Applicant: Honeywell Federal Manufacturing & Technologies, LLC, Kansas City, MO (US)

(72) Inventor: Robert Andrew Metzler, Kansas City, MO (US)

(21) Appl. No.: 18/989,673

(22) Filed: Dec. 20, 2024

Related U.S. Application Data
(60) Provisional application No. 63/614,377, filed on Dec. 22, 2023.

(51) Int. Cl. G01B 5/18

(52) U.S. Cl. CPC G01B 5/18

(57) ABSTRACT

A scratch depth comparator includes a metal block, a first scratch, and a second scratch. The metal block includes a top surface. The first scratch is formed in the top surface with a first scratch depth. The second scratch is formed in the top surface with a second scratch depth that is different than the first scratch depth. The first scratch is formed with two sidewalls sloping from the top surface and located at an angle relative to one another. The angle is about fifty degrees up to about sixty-six degrees.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/614,377; titled “A SCRATCH DEPTH COMPARATOR, ASSEMBLY, AND METHOD OF MAKING A SCRATCH DEPTH COMPARATOR”; and filed Dec. 22, 2023. The Provisional Application is hereby incorporated by reference, in its entirety, into the current patent application.

### STATEMENT REGARDING FEDERALLY-SPONSORED RESEARCH OR DEVELOPMENT

This invention was made with Government support under Contract No.: DE-NA-0002839 awarded by the United States Department of Energy/National Nuclear Security Administration. The Government has certain rights in the invention.

### BACKGROUND

In certain work environments, a worker often needs a quick reference to guide them in determining the acceptability of a scratch on a component. Such circumstances may arise on the floor of a distribution center, in a factory, or in an outdoor environment. The size of the scratch may render the product or object unacceptable for sale. In some contexts, the size of the scratch may affect the performance of the scratched component, thereby justifying more precise examination. However, it is inefficient and unrealistic to bring precise measuring equipment into such work environments where the accuracy of the measurements may be affected by uncontrolled variables or where the expensive equipment could be damaged. Thus, scratch depth comparators are used to aid a worker in spotting a potentially problematic scratch.

However, existing scratch depth comparators are limited for several reasons. Existing commercial scratch depth comparators are electroformed from a milled grandmaster, or standard. It is difficult to form a scratch mimicking a real-world scratch with precision; therefore, the grandmaster is formed using milling machines to cut a groove on a block of metal. The tool of the mill forms an angle at the bottom of the groove in the block. The angle is approximately ninety degrees and is formed in the block by tilting the block forty-five degrees relative to the tool so that the top surface of the block is at an angle relative to a longitudinal axis of the tool. Tilting the block to form the groove introduces additional complexity into the machining process. Further, the ninety-degree angle of the groove does not accurately mimic real-world scratches, and the angle of the groove is invariably replicated in the electroformed scratch depth comparators derived from the grandmaster.

Further, forming a scratch that more accurately mimics a real-world scratch is difficult due to tooling deflection. When forming a scratch, the tool often deflects, which affects the precision of the scratch. The force required to overcome deflection forces often results in the tool tip breaking. This is exacerbated by the dulling of the tool as multiple scratches are created in the block. Thus, forming several scratches on a block to form the grandmaster often results in at least one of the scratches being outside of tolerance or in the tool tip breaking. The scratches must be within tight tolerances so that scratch depth comparators derived from the grandmaster are accurate. Thus, imprecise scratches and obviously broken tooling require the grandmaster formation process to be restarted, which is inefficient and costly.

The background discussion is intended to provide information related to the present invention which is not necessarily prior art.

### SUMMARY

The present invention solves the above-described problems and other problems by providing a scratch depth comparator assembly, a method of making a scratch depth comparator, and a scratch depth comparator.

A scratch depth comparator constructed according to an embodiment of the invention includes a metal block, a first scratch, and a second scratch. The metal block includes a top surface. The first scratch is formed in the top surface with a first scratch depth. The second scratch is formed in the top surface with a second scratch depth that is different than the first scratch depth. The first scratch is formed with two sidewalls sloping from the top surface and located at an angle relative to one another. The angle is about 50 degrees up to about 66 degrees. This results in the formed scratch more accurately mimicking most scratches formed in real-world environments.

Another embodiment of the present invention is a method of forming a scratch depth comparator. The method includes obtaining a negative template derived from the scratch depth comparator assembly described above. The method further includes electroforming a plurality of layers of metal on the negative template to form the scratch depth comparator.

A scratch depth comparator assembly constructed according to an embodiment of the present invention includes a substrate, a first piece, and a second piece. The first piece is attached to the substrate and includes a surface on which a first scratch is formed with a first depth.

The second piece is attached to the substrate and includes a surface on which a second scratch is formed with a second depth that is different than the first depth. Because the two pieces with different scratch depths are attached to a substrate, the formation of the scratch depth comparator assembly does not require forming all the scratches of different depths in a single substrate. This improves the efficiency of the formation of the scratch depth comparator assembly. Further, it enables modular formation of the grandmaster scratch depth comparator assembly so that different variations of a scratch depth comparator can be formed using the grandmaster scratch depth comparator assembly.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWINGS

Embodiments of the present invention are described in detail below with reference to the attached drawing figures, wherein:

FIG. 1 is a perspective view of a top portion of a scratch depth comparator assembly constructed according to an embodiment of the present invention;

FIG. 2 is a right side view of the scratch depth comparator assembly of FIG. 1;

FIG. 3 is a back side view of the scratch depth comparator assembly of FIG. 1;

FIG. 4 is a top plan view of an exemplary piece of the scratch depth comparator assembly of FIG. 1;

FIG. 5 is a side view of the piece of FIG. 3;

FIG. 6 is an enlarged side view of a raised portion and scratch of the piece of FIG. 3;

FIG. 7 is a schematic diagram of a process for forming a scratch depth comparator from the scratch depth comparator assembly of FIG. 1;

FIG. 8 is a perspective view of a scratch depth comparator constructed according to an embodiment of the present invention;

FIG. 9 is a top plan view of the scratch depth comparator of FIG. 8;

FIG. 10 is a side view of the scratch depth comparator of FIG. 8; and

FIG. 11 is a flowchart depicting exemplary steps of a method according to another embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

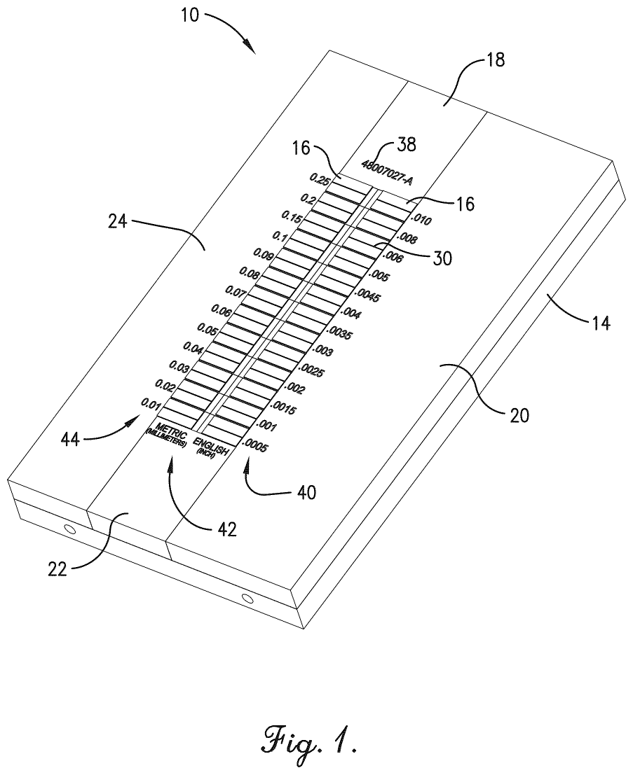

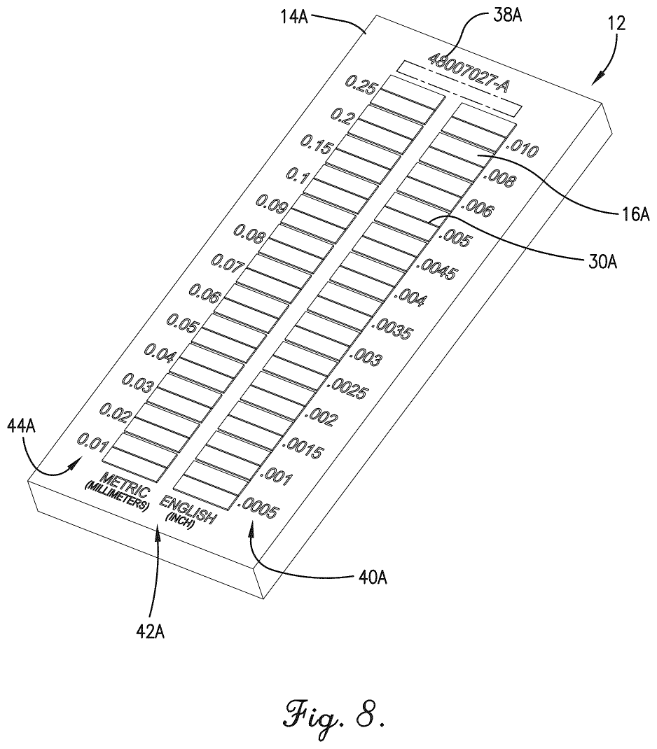

Turning to FIG. 1, a scratch depth comparator assembly 10 constructed according to an embodiment of the present invention is depicted. The scratch depth comparator assembly 10 is operable to be used as a grandmaster or standard for producing a scratch depth comparator 12 (depicted in FIG. 8). The assembly 10 includes a substrate 14, a plurality of pieces 16 attached to the substrate 14, and one or more indicia blocks 18, 20, 22, 24 surrounding the pieces 16.

In one or more embodiments, the substrate 14 comprises a metal plate for attaching the pieces 16 and the indicia blocks 18, 20, 22, 24. Turning to FIG. 3, a backside of the substrate 14 is depicted showing a plurality of cavities 26 formed in the substrate 14 for receiving fasteners 28. The fasteners 28 fasten the pieces 16 and the blocks 18, 20, 22, 24 to the substrate 14. However, the pieces 16 and the blocks 18, 20, 22, 24 may be attached to the substrate 14 any number of ways without departing from the scope of the present invention. Further, one or more of the pieces 16 and/or blocks 18, 20, 22, 24 may be integral to the substrate 14.

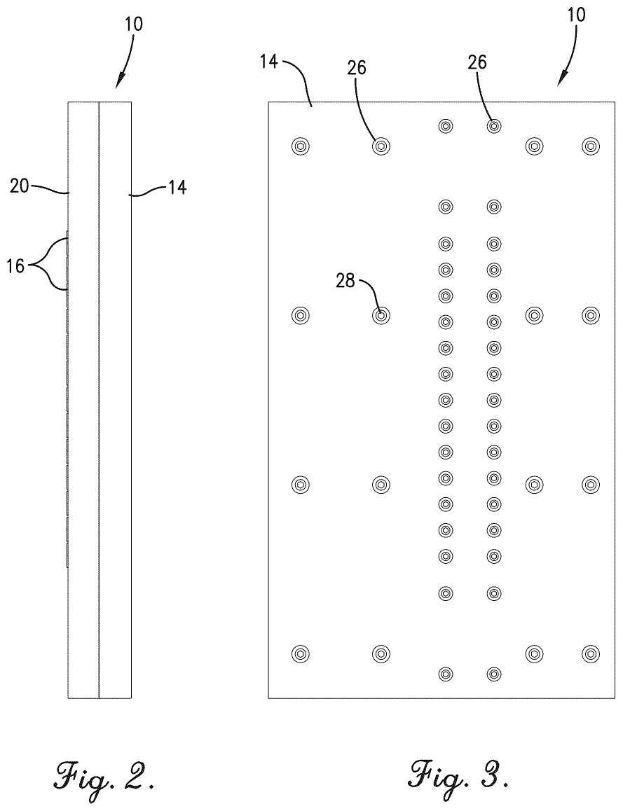

Turning briefly back to FIG. 1, the pieces 16 each include one or more scratch 30 with a unique scratch depth. This enables a user to quickly approximate a scratch depth of a scratch formed in a device or component being examined by comparing the look and/or feel of the replicated scratch 30 in one or more of the pieces 16 with the scratch in the device or component. The user may use their fingernail and/or a pick (such as a toothpick or similar device) to compare the feel of one or more of the scratches 30. In one or more embodiments, the pieces 16 are made of metal, and in some embodiments, the pieces 16 are made of brass. In one or more embodiments, the top surfaces of the pieces 16 are flush with one another and/or the indicia blocks 18, 20, 22, 24, as depicted in FIG. 2.

As depicted in FIG. 1, the scratches 30 may have depths from 0.01 millimeters (mm) up to 0.25 mm, as depicted in the left column of scratches 30. As used herein, “scratch depth” refers to a distance between an imaginary plane extending on the top surface of the piece 16 to the average depth of the scratch 30 along an imaginary axis that is normal relative to the imaginary plane. Referring to the scratches 30 measured in English system units in the right column, the scratches 30 may have depths from 0.0005 inches up to 0.01 inches. The scratch depths may be formed to be within certain tolerances of the applicable indicia 40, 44 (discussed in further detail below). The tolerances of the scratch depths may be from 0.0025 mm up to 0.008 mm, depending on the depth of the scratch 30. For example, the scratches 30 having depths at or below 0.07 mm may have tighter tolerances, such as 0.0025 mm. The scratches 30 having depths at or between 0.08 mm and 0.2 mm may have tolerances of 0.005 mm, and the scratch 30 having the depth of 0.25 mm may have a tolerance of 0.008 mm. The tolerances of the English system scratch depths may be from 0.0001 inches up to 0.0003 inches, depending on the depth of the scratch 30. For example, the scratches 30 having depths at or below 0.0035 inches may have tighter tolerances, such as 0.0001 inches. The scratches 30 having depths at or between 0.004 inches and 0.008 inches may have tolerances of 0.0002 inches, and the scratch 30 having the depth of 0.1 inches may have a tolerance of 0.0003 inches.

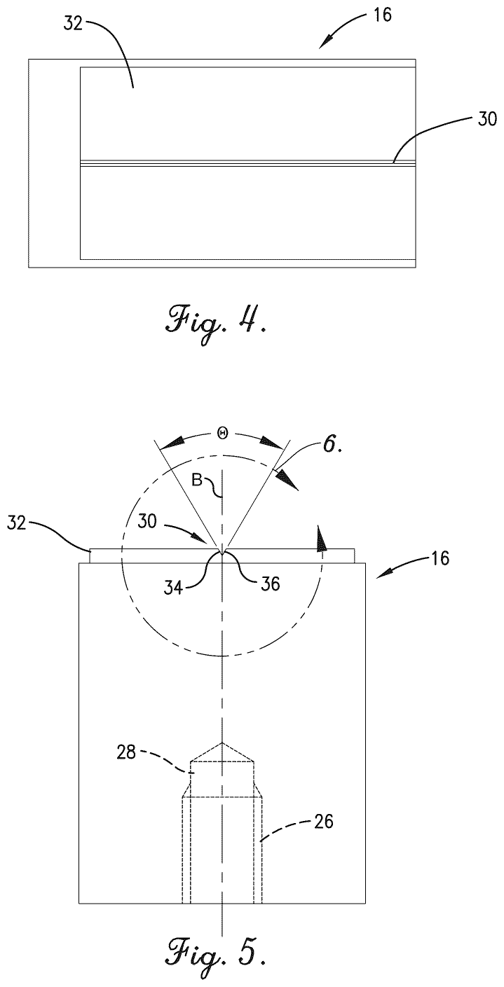

Turning to FIG. 4, a top view of an exemplary piece 16 is depicted. The piece 16 may include a raised portion 32 in which the scratch 30 is formed. The scratch 30 may extend the entire width of the raised portion 32. Turning to FIG. 5, a side view of the piece 16 is depicted. The scratch 30 is formed in the piece 16 so that an angle θ is formed by the sloped walls 34, 36 defining the scratch 30. The scratch 30 is formed by positioning a tool transverse to the top surface of the piece 16 so that the tool forms the angle θ. In one or more embodiments, the tool is positioned perpendicular to the top surface of the piece 16. The angle θ of the scratch 30 may be formed so that an imaginary bisector B that is perpendicular relative to the top surface of the piece 16 extends through the middle of the angle θ. In one or more embodiments, the angle θ formed at the bottom of the scratches 30 are all about sixty degrees plus or minus thirty degrees, depending on the scratch depth. In one or more of embodiments, most of the angles θ of the scratches 30 are about thirty degrees to about ninety degrees. In one or more of embodiments, most of the angles θ of the scratches 30 are about fifty degrees to about sixty-six degrees. In one or more of embodiments, most of the angles θ of the scratches 30 are about fifty-eight degrees to about sixty-two degrees. In one or more embodiments, at least one of the scratches 30 has an angle θ of about sixty degrees.

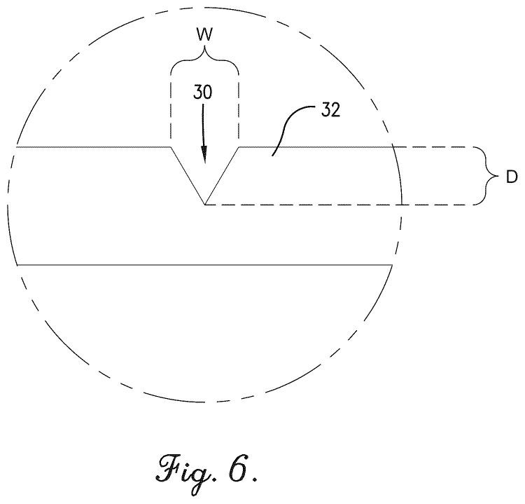

Turning to FIG. 6, the scratches 30 may be formed in their respective pieces 16 with varying widths (W) and the depths (D). As used herein, the width (W) of the scratch 30 means the width as measured across the scratch 30 (perpendicular to its length) along the surface of the piece 16. In one or more embodiments, a ratio of the width (W) of at least one of the scratches 30 over its depth (D) is about 0.93 to about 1.3. In one or more embodiments, at least one of the scratches 30 has such a ratio at about 1.1 to about 1.2. In one or more embodiments, at least one of the scratches 30 has such a ratio at about 1.1547.

Turning back to FIG. 1, the indicia blocks 18, 20, 22, 24 surround the pieces 16 and include various indicia 38, 40, 42, 44 formed thereon. The indicia 38 of the top block 18 includes a tool number of the scratch depth comparator to be formed. The indicia 40 of the block 20 next to the pieces 16 with scratches 30 formed therein measured using the English system represents the scratch depths of their respective pieces in English system units, and particularly in inches. The indicia 42 of the block 22 below the pieces 16 includes an indication of which column of pieces 16 is measured in metric system units and which is measured in English system units. The indicia 44 of the block 24 next to the pieces 16 with scratches 30 formed therein measured using the metric system represents the scratch depths of their respective pieces in metric system units, and particularly in millimeters. The pieces 16 and blocks 18, 20, 22, 24 may be arranged any number of ways on the substrate 14 without departing from the scope of the present invention. Further, the substrate 14, pieces 16, and blocks 18, 20, 22, 24 may be formed in any number of shapes without departing from the scope of the present invention.

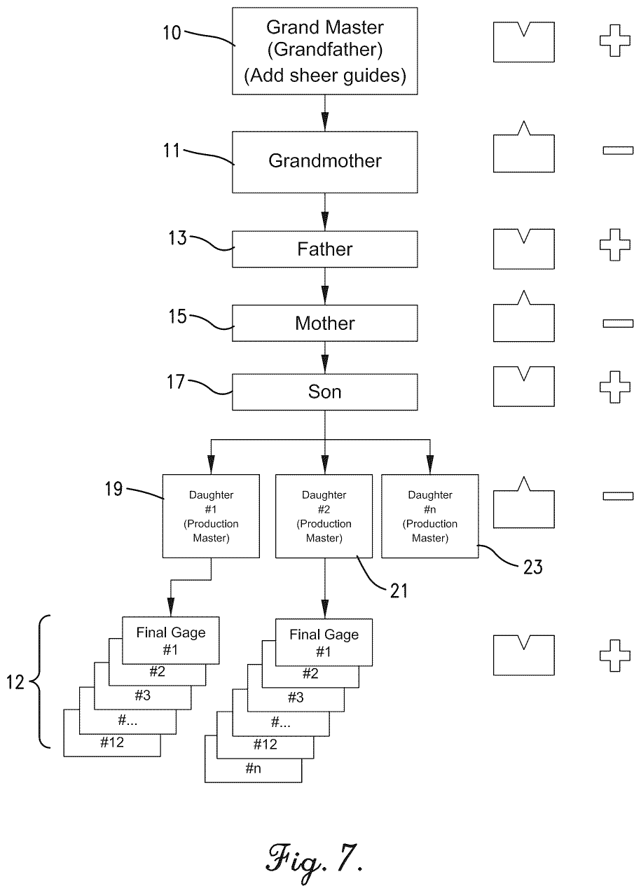

Once the scratch depth comparator assembly 10 is assembled, it can be used for forming a number of standards for redundancy purposes and for manufacturing scratch depth comparators. As depicted in FIG. 7, the scratch depth comparator assembly 10 may be used as a “grand master” or “grandfather” standard from which one or more first negative(s) (or grandmother(s)) 11 is formed. The negative 11 may be formed using electroforming. As used herein, “electroforming” may be any metal forming process that uses electrical current to deposit metal onto a conductive substrate or object (such as the scratch depth comparator assembly 10), which is later removed to leave behind a metal part (such as a negative template or a precursor thereto). Then, one or more positive(s) 13, or father(s), may be formed from the first negative 11. The positive 13 may likewise be formed using electroforming techniques with the negative 11 being used as a mold. The positive 13 may be used as the end product; however, for redundancy purposes, one or more additional negative(s) 15 may be formed from the positive 13. This may be repeated any number of times to form one or more additional positive(s) 17 (or sons). Finally, one or more production masters 19, 21, 23 may be formed from the prior positive 17, such as through electroforming processes. From the production masters 19, 21, 23, positive end product scratch depth comparators 12 may be formed that have tight tolerances in terms of scratch depths to the original scratch depth comparator assembly 10.

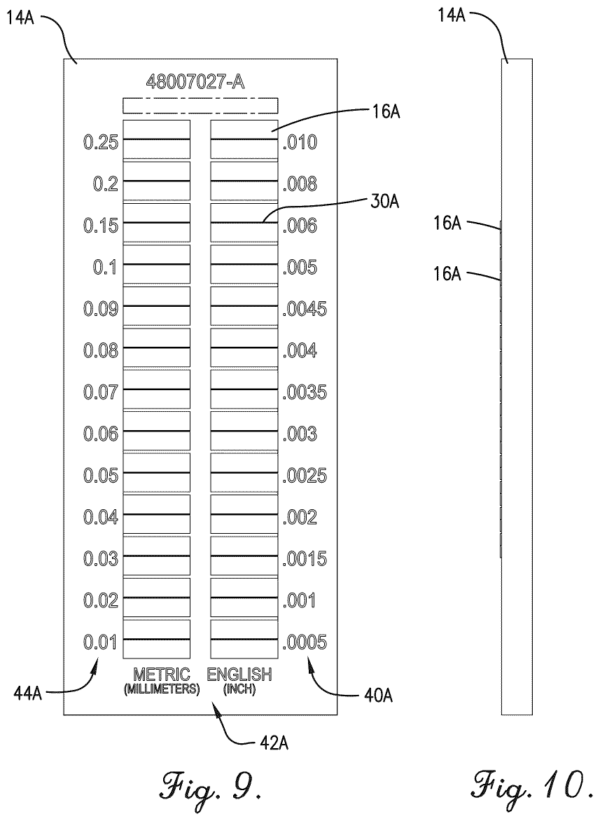

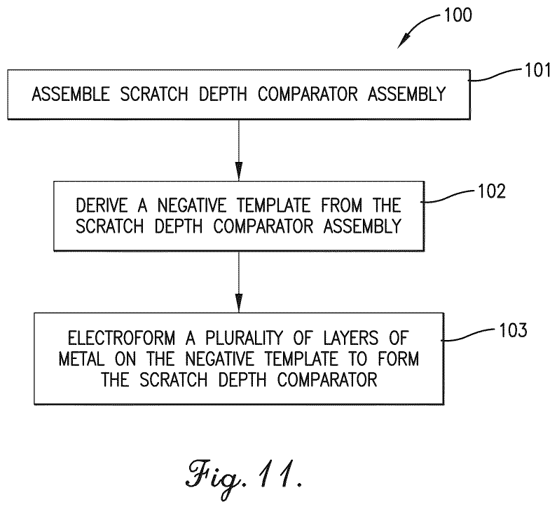

A scratch depth comparator 12 constructed in accordance with an embodiment of the invention is shown in FIGS. 8-10. The scratch depth comparator 12 comprises features that correspond to the features of the scratch depth comparator assembly 10; thus, the features of scratch depth comparator 12 that correspond to features in the scratch depth comparator assembly 10 have an ‘A’ appended to their reference numerals.

The scratch depth comparator 12 may be derived from the scratch depth comparator assembly 10 any number of ways without departing from the scope of the present invention, including the method described below. The scratch depth comparator 12 may be any generation of scratch depth comparator derived from the scratch depth comparator assembly 10 without departing from the scope of the present invention. As used herein, the term “derived” includes indirect and direct derivation. For example, the scratch depth comparator assembly 10 may be formed, and a negative template of the scratch depth comparator assembly 10 may be formed using electroforming, as discussed elsewhere herein. The scratch depth comparator 12 may be formed via electroforming with the negative template or a derivative of the negative template. Alternatively, the scratch depth comparator 12 may be formed through other means (including through methods that do not use the scratch depth comparator assembly 10) without departing from the scope of the present invention. In one or more embodiments, the scratch depth comparator 12 comprises nickel and/or is formed of nickel.

Similar to scratch depth comparator assembly 10, the scratch depth comparator 12 includes a metal block 14A with a plurality of portions 16A formed thereon. Each portion 16A has one or more scratchs 30A formed therein. The scratch depth comparator 12 further includes indicia 38A, 40A, 42A, 44A corresponding to the indicia 38, 40, 42, 44 on the assembly 10. Specifically, indicia 38A represents the tool number, indicia 40A represents the scratch depths measured in the English system, indicia 42A indicates the measurement systems, and indicia 44A represents the scratch depths measured in the metric system. The plurality of portions 16A and the portions of the metal block 14A containing the indicia 38A, 40A, 42A, 44A may be integrally formed as one piece. However, the scratch depth comparator 12 may be formed with any number of pieces without departing from the scope of the present invention.

The scratch depths of the scratches 30A may be substantially the same as the scratch depths of the scratches 30 in the scratch depth comparator assembly 10. As used in this context, “substantially the same” means that the scratch depths are within certain desired tolerances of the scratch depths of the assembly 10 and/or the applicable indicia 40A, 44A. The tolerances of the scratch depths may be from 0.0025 mm up to 0.008 mm, depending on the depth of the scratch 30A. For example, the scratch 30A having depths at or below 0.07 mm may have tighter tolerances, such as 0.0025 mm. The scratch 30A having depths at or between 0.08 mm and 0.2 mm may have tolerances of 0.005 mm, and the scratch 30A having the depth of 0.25 mm may have a tolerance of 0.008 mm. The tolerances of the English system scratch depths may be from 0.0001 inches up to 0.0003 inches, depending on the depth of the scratch 30A. For example, the scratches 30A having depths at or below 0.0035 inches may have tighter tolerances, such as 0.0001 inches. The scratches 30A having depths at or between 0.004 inches and 0.008 inches may have tolerances of 0.0002 inches, and the scratch 30A having the depth of 0.1 inches may have a tolerance of 0.0003 inches. Similarly, the scratch 30A are formed in the portions 16A so that imaginary bisectors of their angles are perpendicular relative to the top surfaces of the respective portions 16A. In one or more embodiments, the angle formed at the bottom of the scratches 30A are all about sixty degrees plus or minus thirty degrees, depending on the scratch depth, corresponding to the angles θ of the scratches 30 of the scratch depth comparator assembly 10. In one or more embodiments, most of the angles of the scratches 30A are about fifty degrees to about sixty-six degrees. In one or more embodiments, at least one of the scratches 30A has an angle of about sixty degrees.

In one or more embodiments, a ratio of the width of at least one of the scratches 30A over its depth is about 0.93 to about 1.3 corresponding to the dimensions of the corresponding scratch 30 of the scratch depth comparator assembly 10. In one or more embodiments, at least one of the scratches 30A has such a ratio at about 1.1 to about 1.2. In one or more embodiments, at least one of the scratches 30A has such a ratio at about 1.1547.

The flow chart of FIG. 11 depicts the steps of an exemplary method 100 of forming one or more scratch depth comparator. In some alternative implementations, the functions noted in the various blocks may occur out of the order depicted in FIG. 11. For example, two steps shown in succession in FIG. 11 may in fact be executed substantially concurrently, or the steps may sometimes be executed in the reverse order depending upon the functionality involved. In addition, some steps may be optional. The method 100 is described below, for case of reference, as being executed by exemplary devices and components introduced with the embodiments illustrated in FIGS. 1-6.

Referring to step 101, a scratch depth comparator assembly is assembled. The scratch depth comparator assembly may be assembled by forming a substrate and attaching a plurality of pieces to the substrate having scratches with different depths. The substrate and pieces may comprise a metal substrate and a plurality of metal blocks. In one or more embodiments, the metal blocks are made of brass.

This step may include forming one or more scratches in the metal blocks. The scratches may be formed using a tool connected to a jig grinder, such as a Hauser™ H55 Jig Grinder or the like. The tool may be any tool that includes a sharpened edged capable of imparting a scratch in metal, such as a deburr tool, a knife, a high-speed lathe bit, or the like. In one or more embodiments, this step includes sharpening the edge of the tool so that the edge has a fifty-five to sixty-five degree angle. In one or more embodiments, the edge of the tool is shaped to have a sixty-degree angle.

In one or more embodiments, the scratches are formed by applying the tool to raised portions of the blocks and plowing the tool straight across the widths of the raised portions of the blocks. The scratches may be formed by applying the tool perpendicularly to the surface of the blocks. In one or more embodiments, the scratches are measured for proper angle and scratch depth. In one or more embodiments, the scratches are measured using a confocal laser scanning microscope. This step may include hand lapping or polishing the block to bring the depth within a desired tolerance. The blocks with scratches within tolerances are then attached to the substrate. For example, the blocks may be fastened to the metal plate substrate using fasteners.

Referring to step 102, a negative template is derived from the scratch depth comparator assembly. The negative template may be directly derived from the scratch depth comparator assembly or indirectly derived from the scratch depth comparator assembly, such as by using a derivation (positive template) of the scratch depth comparator assembly. The negative template may be electroformed using the scratch depth comparator assembly or a derivation thereof. The negative template may include features that are complementary to the features of the scratch depth comparator assembly. For example, it may include projections corresponding to the scratches of the scratch depth comparator assembly for forming scratches of the scratch depth comparator.

Referring to step 103, a plurality of layers of metal are electroformed on the negative template to form the scratch depth comparator. The layers may be formed one layer at a time until the desired thickness of the scratch depth comparator is achieved. The scratch depth comparator can then be removed from the negative template.

The method 100 may include additional, less, or alternate steps and/or device(s), including those discussed elsewhere herein.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth in any subsequent regular utility patent application. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

1. A scratch depth comparator comprising:
a metal block having a top surface;
a first scratch formed in the top surface with a first scratch depth;
a second scratch formed in the top surface with a second scratch depth that is different than the first scratch depth;
wherein the first scratch is formed with two sidewalls sloping from the top surface and located at an angle relative to one another is about fifty degrees up to about sixty-six degrees.

2. The scratch depth comparator of claim 1, wherein the first scratch depth and the second scratch depth have tolerances of about 0.005 mm.

3. The scratch depth comparator of claim 1, wherein the first scratch depth and the second scratch depth have tolerances of about 0.0025 mm.

4. The scratch depth comparator of claim 1, wherein the first scratch depth is in a range at or between about 0.008 mm to about 0.25 mm.

5. The scratch depth comparator of claim 1, wherein the metal block comprises nickel.

6. A method of forming a scratch depth comparator, the method comprising:
obtaining a negative template derived from a scratch depth comparator assembly, the scratch depth comparator assembly comprising:
a substrate;
a first piece attached to the substrate and including a surface on which a first scratch is formed with a first depth; and
a second piece attached to the substrate and including a surface on which a second scratch is formed with a second depth that is different than the first depth; and
electroforming a plurality of layers of metal on the negative template to form the scratch depth comparator.

7. The method of claim 6, wherein the scratch depth comparator includes:
a formed first scratch corresponding to the first scratch of the first piece of the scratch depth comparator assembly, the formed first scratch having a first scratch depth corresponding to the first depth of the first scratch,
a formed second scratch corresponding to the second scratch of the second piece of the scratch depth comparator assembly, the formed second scratch having a second scratch depth corresponding to the second depth of the second scratch.

8. The method of claim 7, wherein the first scratch depth is in a range at or between about 0.008 mm to about 0.25 mm.

9. The method of claim 7, wherein the first scratch depth is at or within 0.005 mm of the first depth and the second scratch depth is at or within 0.005 mm of the second depth.

10. The method of claim 6, further comprising:
forming the first scratch on the first piece using an edge of a tool, the edge having an angle of about fifty-five degrees to about sixty-five degrees;
determining that the first scratch has the first depth; and
attaching the first piece to the substrate.

11. The method of claim 10, further comprising:
forming the second scratch on the second piece using the edge of the tool;
determining that the second scratch has the second depth; and
attaching the second piece to the substrate.

12. The method of claim 6, wherein the first piece and the second piece are made of brass, and the scratch depth comparator is made of nickel.

13. The method of claim 6, wherein a top surface of the first piece is flush with a top surface of the second piece.

14. The method of claim 6, wherein the negative template comprises projections that are complementary to the first scratch and the second scratch of the scratch depth comparator assembly.

15. The method of claim 6, further comprising electroforming the negative template using a positive template derived from the scratch depth comparator assembly.

16. A scratch depth comparator assembly comprising:
a substrate;
a first piece attached to the substrate and including a surface on which a first scratch is formed with a first depth; and
a second piece attached to the substrate and including a surface on which a second scratch is formed with a second depth that is different than the first depth.

17. The scratch depth comparator assembly of claim 16, wherein the substrate is a metal plate with a top surface, and the first piece and the second piece are metal blocks attached to the top surface of the metal plate.

18. The scratch depth comparator assembly of claim 16, wherein a top surface of the first piece is flush with a top surface of the second piece.

19. The scratch depth comparator assembly of claim 16, further comprising an indicator block attached to the substrate adjacent to the first piece and the second piece and including indicia representing the first depth and the second depth.

20. The scratch depth comparator assembly of claim 16, wherein the first scratch is defined by two sidewalls that are oriented relative to one another at an angle of about 50 to about 66 degrees.
